(19) United States
(12) Patent Application Publication
(10) Pub. No.: US 2016/0338370 A1
(43) Pub. Date: Nov. 24, 2016

(54) SOLID PROTEIN PREPARATIONS

(71) Applicant: DMK Deutsches Milchkontor GmbH, Zeven (DE)

(72) Inventor: Martin May, Dorentrup (DE)

(21) Appl. No.: 15/152,933

(22) Filed: May 12, 2016

(30) Foreign Application Priority Data
May 18, 2015 (EP) 15168048.5

(51) Int. Cl. A23C 20/00; A23J 3/14; A23J 3/26; A23J 3/10

(52) U.S. Cl. CPC A23C 20/00; A23J 3/10; A23J 3/14; A23J 3/26

(57) ABSTRACT

A solid protein preparation is proposed which is obtainable in that
(a) proteins from natural sources are fed into a screw extruder,
(b) a denaturant is added to the mass during the extrusion operation, and
(c) the extruded and denatured mass is shaped after it leaves the extruder.

The preparation serves as an inexpensive cheese substitute.

### FIELD OF THE INVENTION

The invention is within the field of dairy products and relates to solid protein masses having cheese texture which can be produced rapidly and inexpensively and can serve as cheese substitute.

### PRIOR ART

The first cheese substitute was developed as early as the end of 19^{th} century in USA and was also soon produced in Europe. To produce it, skimmed milk obtained by centrifugation was mixed with liquid beef tallow (oleomargarine) and coagulated with rennet. This product was markedly cheaper than cheese by replacing the milk fat with the cheaper beef tallow. Common names, in addition to analogue cheese, were lard cheese, oleomargarine cheese or margarine cheese. With the rise of veganism as a dietary form that completely dispenses with animal products, since 2010 there has been a greater and greater demand and therefore a market for vegan cheese which simulates the properties of true cheese such as taste and protein content, without animal ingredients. For current cheese substitutes, usually water, milk protein, soybean or bacterial protein and vegetable oils such as palm oil serve as basic materials, sometimes also starch. Further ingredients are emulsifiers, flavourings and dyes, salt and taste enhancers, in order to approximate the taste and appearance of patterns such as parmesan, emmental, mozzarella, feta or camembert. Since no ripening process is necessary, the production time can be greatly reduced in comparison with true cheese. For the production, vegetable fat is heated, mixed with a pre-prepared dry mix and water, heated, and then flavour concentrate is stirred in and everything is packaged and cooled.

Reasons for the use of cheese substitutes are the considerably lower production price compared with cheese and properties such as melting behaviour and heat stability (up to 400° C.) that are adjustable by the composition of the ingredients, which adjustable properties facilitate the production and further processing. Depending on the starting material, appropriate preparations are not only of interest for people having a vegan lifestyle, but also for cheese lovers having lactose intolerance.

Cheese substitutes are used in Western Europe and the USA predominantly gastronomy and bakeries, e.g. for pizza, lasagna or cheese rolls, more rarely in the food industry in convenience products for end consumers. In Germany alone, the production rate is over 100 000 tonnes per year. In Eastern Europe and in Southern countries, cheese substitutes are also frequently found in packaged ready-to-eat dishes.

In the prior art, methods for producing differing cheese substitute are already known. Those which may be mentioned as representatives are:

Subject matter of CA 1169698 A1 (Nestle) is a method for producing pasteurized cheese in powder form, in which a colloidal lactic acid solution having a high protein/lactose and protein/calcium ratio (at least twice as high as raw milk) and a pH from 5.0 to 5.5 is processed, the resultant solution is made alkaline, pasteurized, and after renewed acidification dried. Alternatively, it is possible first to acidify the raw milk and then, after ultrafiltration, alkalization and acidification to dry it. The powder that is produced can be reconstituted with water and then converted into a mozzarella-like product. In this manner, here also, the texture does not correspond to that of semi-hard cheese.

EP 1825758 A2 (Kraft) is concerned with a method for producing a cheese product, wherein a mixture of high-quality protein powder, milk powder and salt with water and other alternative additives is mixed, the resultant intermediate product is admixed with water, fats, other milk products and suitable and cooked at a temperature from 65 to 121° C. Although the texture is termed smooth, it corresponds to that of soft cheese.

It is disadvantageous that there is a lack of cheese substitutes and corresponding production methods that, on the basis of different protein sources, are flexibly, rapidly and inexpensively producible, have a high nutritional value, have particular storage stability and in particular have a texture which corresponds to that of popular semi-hard cheeses.

The object of the present invention was therefore to provide, on the basis of natural protein sources, preferably surplus protein sources, rapidly, inexpensively and continuously a high-quality cheese substitute which, with respect to nutrient content and texture, does not differ from commercial cheese varieties such as gouda, emmental or maasdammer, that is to say typical semi-hard cheeses.

### DESCRIPTION OF THE INVENTION

A first subject matter of the invention therefore relates to a solid protein preparation which is obtainable in that

(a) proteins from natural sources are fed into a screw extruder,
(b) a denaturant is added to the mass during the extrusion operation, and
(c) the extruded and denatured mass is shaped after it leaves the extruder.

A further subject matter of the invention relates to an analogous, preferably continuous, method for producing a solid protein preparation, in which

(a) proteins from natural sources are fed into a screw extruder,
(b) a denaturant is added to the mass during the extrusion operation, and
(c) the extruded and denatured mass is shaped after it leaves the extruder.

Surprisingly, it has been found that differing protein sources, namely both plant and animal protein sources may be converted in an extruder, using acidulants or rennet with high throughput into a preparation which corresponds in texture thereof to semi-hard cheese. By adding flavourings, taste enhancers, spices, salts, dyes and the like, special natural cheese varieties may be simulated virtually identically. By avoiding animal proteins, or by the use of protein sources which no longer contain lactose, preparations may be produced which are especially also suitable for vegans and people with lactose intolerance.

Protein Sources

Natural protein sources which come into consideration in the context of the invention are plant proteins and/or animal proteins, especially milk proteins and also mixtures thereof. Examples of suitable plant proteins are wheat proteins, pea proteins or potato proteins. Animal proteins that come into consideration are primarily milk proteins and/or whey proteins, which are on the market as corresponding concentrates in powder form.

Preferably, the proteins are used with a dry matter in the range from about 15 to about 60% by weight, and in particular about 20 to about 50% by weight, and preferably about 30 to about 45% by weight.

In addition, protein fractions can be used that contain casein and/or lactose as further components.

Extrusion

The method according to the invention is carried out in an extruder. These are taken to mean conveying apparatuses which express, by the principle of functioning of the screw conveyor, solid to viscous masses at high pressure and high temperature uniformly from a shaping opening. This method is termed extrusion.

In principle, extruders can be subdivided into two processing principles: processing extruders and compounding extruders. Processing extruders serve principally for shaping (generally single-shaft extruders), whereas compounding extruders serve for the chemical and/or physical modification (reaction, mixing, degassing etc.) of substances (co-rotating close-meshing twin-shaft extruders, Buss kneaders etc.).

Suitable extruders are those having one, two or a plurality of screw shafts. In the case of extruders having two screws, a differentiation is made between co-rotating and counter-rotating twin-screw extruders. In the co-rotating twin-screw extruder, the screws rotate in the same direction of rotation, in the case of the counter-rotating extruders, they rotate in an opposite direction of rotation. The transport and pressure build up in the single-screw and co-rotating twin-screw extruder are caused by the friction of the mass rotating with the screw on the stationary housing wall (cylinder)—in this context this is called friction transport. The mass thus remaining in rotation is pushed by the spiral-shaped screw flights towards the outlet nozzle. In the counter-rotating twin-screw extruder, the principle of forced transport predominates. In the context of the invention, twin-screw extruders are preferred. In the context of the invention, 25D, 30D, 40D and the like come into consideration, which is to say that 25 times (30 times, 40 times etc.) the screw diameter gives the length. To increase the output, single-screw extruders, termed fast runners, having speeds of rotation of up to 1500 rotations per minute can also be used.

According to the invention, the extrusion is carried out at a temperature in the range from about 50 to about 95° C.—based on the barrel temperature of the extruder. The pressure in this case can be about 1 to about 300 bar. Preferably, the extrusion is carried out with a throughput of about 200 to about 7000 kg/h.

Denaturants

For conversion of the proteins to a cheese substitute, a denaturing operation is required that proceeds rapidly and completely under the conditions according to the invention, in particular the temperature and pressure conditions. For this purpose the mass, in a first embodiment, is added to a food acid source. Although it is possible in principle to add this source already to the protein mass, however, it proves to be simpler to feed the source separately into the extruder, either via an inlet at the start of the extrusion section or via a plurality of inlet valves that are distributed over the extrusion section. The amount of denaturant is typically about 0.5 to about 4% by weight, and in particular about 1 to about 2% by weight, in each case based on the protein mass.

Acid sources that come into consideration are the following food acids:

E 260—acetic acid
E 270—lactic acid
E 290—carbon dioxide
E 296—maleic acid
E 297—fumaric acid
E 330—citric acid
E 331—sodium citrate
E 332—potassium citrate
E 333—calcium citrate
E 334—tartaric acid
E 335—sodium tartrate
E 336—potassium tartrate
E 337—sodium-potassium tartrate
E 338—phosphoric acid
E 353—metatartaric acid
E 354—calcium tartrate
E 355—adipic acid
E 363—succinic acid
E 380—triammonium citrate
E 513—sulphuric acid
E 574—gluconic acid
E 575—glucono-delta-lactone

Preferred acidulants are citric acid, lactic acid, and, in particular, glucono-delta-lactone, and also mixtures thereof. The lactone is very particularly suitable for the method according to the invention because it releases the acid continuously over the entire extrusion operation which leads to a particularly homogeneous product.

Alternatively, rennet, that is to say a natural mixture of the enzymes chymosin and pepsin, can also be added as denaturant to the mass during the extrusion.

Auxiliaries and Additives

In a further embodiment of the present invention, it is provided to add to the mass during the extrusion further auxiliaries and additives such as, for example, starter cultures, probiotic microorganisms, prebiotic substances, emulsifiers, thickeners, flavourings, taste enhancers, salts (especially common salt), herbs, vitamins, antioxidants, food dyes and the like in amounts of, for example, about 0.1 to about 10% by weight, preferably about 0.5 to about 8% by weight, in particular about 1 to about 5% by weight, and particularly preferably about 2 to about 3% by weight.

Starter Cultures and Probiotic Microorganisms

Probiotic microorganisms, also called “probiotics”, which form the group (N), are living microorganisms that have properties useful for the host. According to the definition of the FAO/WHO, probiotics are “live microorganisms which when administered in adequate amounts confer a health benefit on the host”. Lactic acid bacteria (LAB) and bifidobacteria are the best known probiotics; however, various yeasts and bacilli can also be used. Probiotics are customarily consumed as a component of fermented foods to which special living cultures have been added, such as, e.g., yoghurt, soy yoghurt or other probiotic foods. Furthermore, tablets, capsules, powders and sachets are also obtainable which contain the microorganisms in freeze-dried form. Table B gives an overview of commercial probiotics and the associated claims for health that can be used in the context of the present invention as component (b1).

TABLE A
Probiotic materials

| Strain | Name | Manufacturer | Claims |
|---|---|---|---|
| Bacillus coagulans GBI- | GanedenBC | Ganeden Biotech | Increases the immune response |
| 30, 6086 | | | in the event of viral infection. |
| Bifidobacterium | Probio-Tec | Chr. Hansen | Clinical studies on humans have |
| animalis subsp. lactis | Bifidobacterium | | found that BB-12, alone, or in |
| BB-12 | BB-12 | | combination, beneficially |
| | | | influences the gastrointestinal |
| | | | system. |
| Bifidobacterium | Align | Procter & Gamble | In a preliminary study it was |
| infantis 35624 | | | found that the bacterium can |
| | | | decrease abdominal pains. |
| Lactobacillus | | Danisco | It is clear from a study that the |
| acidophilus NCFM | | | side effects of antibiotic |
| | | | treatments are decreased. |
| Lactobacillus | | | |
| paracasei St11 (or | | | |
| NCC2461) | | | |
| Lactobacillus | | Nestlé | Decreases gastritis complaints |
| johnsonii La1 | | | and reduces inflammations. |
| (=Lactobacillus | | | |
| LC1, Lactobacillus | | | |
| johnsonii NCC533) | | | |
| Lactobacillus | GoodBelly/ | Probi | Could improve IBS symptoms; |
| plantarum 299v | ProViva/ProbiMage | | however further studies still |
| | | | required. |
| Lactobacillus | | BioGaia | First indications of an activity |
| reuteri American Type | | | against gingivitis, fever in |
| Culture Collection\|ATTC | | | children and decreasing the |
| 55730 (Lactobacillus | | | number of days of illness for |
| reuteri SD2112) | | | adults. |
| Lactobacillus | | | |
| reuteri Protectis (DSM | | | |
| 17938, daughter strain | | | |
| of ATCC 55730) | | | |
| Lactobacillus | | | |
| reuteri Protectis (DSM | | | |
| 17938, daughter strain | | | |
| of ATCC 55730) | | | |
| Saccharomyces | DiarSafe and | Wren Laboratories | Restricted evidence in the |
| boulardii | others | | treatment of acute diarrhoea. |
| Lactobacillus | Bion Flore Intime/ | Chr. Hansen | Evidence of activity against |
| rhamnosus GR-1 | Jarrow Fem- | | vaginitis in one study. |
| & Lactobacillus | Dophilus | | |
| reuteri RC-14 | | | |
| Lactobacillus | Florajen3 | American Lifeline, | First indications of activity |
| acidophilus NCFM | | Inc | against CDAD |
| & Bifidobacterium | | | |
| bifidum BB-12 | | | |
| Lactobacillus | Bio-K+ | Bio-K+ | Indications of improvement in |
| acidophilus CL1285 | CL1285 | International | digestion, especially with |
| & Lactobacillus | | | respect to lactose intolerance. |
| casei LBC80R | | | |
| Lactobacillus | Bravo Friscus/ | Probi | Studies currently proceeding on |
| plantarum HEAL 9 | ProbiFrisk | | effectiveness against colds. |
| & Lactobacillus | | | |
| paracasei 8700:2 | | | |

Hereinafter, two further forms of lactic acid bacteria are mentioned which likewise can be used as starter cultures or as probiotics:
Lactobacillus bulgaricus;
Streptococcus thermophilus;
Streptococcus thermophilus,
Leuconostoc species,
Lactococcus lactis subsp. lactis biovar diacetylactis,
Lactococcus lactis subsp. lactis,
Lactococcus lactis subsp. cremoris, and
Bifidobacterium lactis B12.

Prebiotic Materials

In a further embodiment of the invention, the preparations can additionally contain prebiotic materials (“prebiotics”), which form group H. Prebiotics are defined as indigestible food components, the administration of which stimulates the growth or activity of a number of useful bacteria in the large intestine. The addition of prebiotic compounds improves the stability of anthocyanines against breakdown processes in the digestive tract. Various substances appear below, in particular carbohydrates, which are particularly preferred prebiotics in the context of the invention.

Fructo Oligosaccharides.

Fructo oligosaccharides, or FOS for short, comprise, in particular, short-chain representatives having 3 to 5 carbon atoms, such as, for example, D-fructose and D-glucose. FOS, also called neosugars, are commercially produced on the base of sucrose and the enzyme fructosyl transferase that is obtained from fungi. FOS support, in particular, the growth of bifidobacteria in the intestine and are marketed, primarily, in the USA together with probiotic bacteria in various functionalized foods.

Inulins.

Inulins are part of a group of naturally occurring fructose-containing oligosaccharides. They belong to a class of carbohydrates that are termed fructans. They are obtained from the roots of the chicory plant (Cichorium intybus) or what are termed Jerusalem artichokes. Inulins predominantly consist of fructose units and typically have one glucose unit as an end group. The fructose units are in this case linked to one another via a beta-(2-1)glycosidic bond. The mean degree of polymerization of inulins that are used as prebiotics in the food sector is 10 to 12. Inulins likewise stimulate the growth of bifidobacteria in the large intestine.

Isomalto Oligosaccharides.

This group is a mixture of alpha-D-linked glucose oligomers, including isomaltose, panose, isomaltotetraose, isomaltopentaose, nigerose, kojibiose, isopanose and higher branched oligosaccharides. Isomalto oligosaccharides are produced by various enzymatic pathways. They likewise stimulate the growth of bifidobacteria and lactobacilli in the large intestine. Isomalto oligosaccharides are especially used in Japan in functionalized foods as food additives. In the interim, they are also used in the USA.

Lactilol.

Lactilol is the disaccharide of lactulose. Its medical use is against constipation and in the case of hepatic encephalopathy. In Japan, lactilol is used as a prebiotic. It withstands breakdown in the upper digestive tract, but is fermented by various intestinal bacteria, which leads to an increase in the biomass of bifidobacteria and lactobacilli in the intestine. Lactilol is also known under the chemical name 4-0-(beta-D-galactopyranosyl)-D-glucitol. The medical field of application of lactilol in the USA is limited because of the lack of studies; in Europe, it is preferably used as a sweetener.

Lactosucrose.

Lactosucrose is a trisaccharide that is made up of D-galactose, D-glucose and D-fructose. Lactosucrose is produced by the enzymatic transfer of the galactosyl radical in lactose to sucrose. It is broken down neither in the stomach nor in the upper part of the digestive tract, and is exclusively consumed by bifidobacteria for growth. From physiological aspects, lactosucrose acts as a stimulator for the growth of the intestinal flora. Lactosucrose is likewise known as 4G-beta-D-galactosucrose. It is widespread in Japan as a food additive and as a component of functionalized food, in particular also as an additive for yoghurt. Lactosucrose is currently being tested in the USA also for a similar application.

Lactulose.

Lactulose is a semisynthetic disaccharide of D-lactose and D-fructose. The sugars are linked via a beta-glycosidic bond which makes them resistant to hydrolysis by digestive enzymes. Instead, lactulose is fermented by a restricted number of intestinal bacteria, which leads to a growth, in particular of lactobacilli and bifidobacteria. Lactulose in the USA is a prescription drug against constipation and hepatic encephalopathy. In Japan, in contrast, it is sold freely as a food additive and component of functionalized foods.

Pyrodextrins.

Pyrodextrins comprise a mixture of glucose-containing oligosaccharides that are formed in the hydrolysis of starch. Pyrodextrins promote the proliferation of bifidobacteria in the large intestine. These are also not broken down in the upper intestinal region.

Soyaoligosaccharides.

This group comprises oligosaccharides that are substantially to be found only in soybeans, and, in addition, in other beans and also peas. The two leading representatives are the trisaccharide raffinose and the tetrasaccharide stachyose. Raffinose is composed of one molecule each of D-galactose, D-glucose and D-fructose. Stachyose consists of two molecules of D-galactose and also one molecule each of D-glucose and D-fructose. Soyaoligosaccharides stimulate the growth of bifidobacteria in the large intestine and are already being used in Japan as food additives and also in functionalized foods. In the USA they are currently being tested for this application.

Transgalactooligosaccharides.

Transgalactooligosaccharides (TOS) are mixtures of oligosaccharides based on D-glucose and D-galactose. TOS are produced starting from D-lactose in the presence of the enzyme betaglucosidase from Aspergillus oryzae. As with many other prebiotics, TOS are also stable in the small intestine and stimulate the growth of bifidobacteria in the large intestine. TOS are already marketed as food additives both in Europe and in Japan.

Xylooligosaccharides.

Xylooligosaccharides contain beta-1,4-linked xylose units. The degree of polymerization of the xylooligosaccharides is between 2 and 4. They are obtained by enzymatic hydrolysis of the polysaccharide xylan. They are already marketed in Japan as food additives, in the USA they are still in the testing phase.

Biopolymers.

Suitable biopolymers which likewise come into consideration as prebiotics, such as, for example, beta-glucans, are distinguished in that they are produced on the basis of plants, for example, as raw material sources, cereals such as oats and barley, but also fungi, yeast and bacteria come into consideration. Also suitable are microbially produced cell wall suspensions or entire cells having a high beta-glucan content. Residual fractions of monomers have 1-3 and 1-4 or 1-3 and 1-6 links, wherein the content can vary greatly. Preferably, beta-glucans are obtained on the basis of yeasts, in particular saccharomyces, especially Saccharomyces cerevisiae. Other suitable biopolymers are chitin and chitin derivatives, in particular oligoglucosamine and chitosan, which is a typical hydrocolloid.

Galactooligosaccharides (GOS).

Galactooligosaccharides are produced by the enzymatic conversion of lactose, a component of bovine milk. GOS comprise in general a chain of galactose units that are formed by sequential transgalactosylation reactions and which have a terminal glucose unit. Terminal glucose units are usually formed by premature hydrolysis of GOS. The degree of polymerization of GOS can apparently vary very greatly and extends from 2 to 8 monomer units. A series of factors determine in this case the composition and order of monomer units: the enzyme source, the starting material (lactose concentration and origin of the lactose) the enzymes participating in the process, conditions during processing and the composition of the medium.

Emulsifiers

Emulsifiers are distinguished by the important property of being soluble not only in water but also in fat. Emulsifiers generally consist of fat-soluble part and a water-soluble part. Emulsifiers are always used when water and oil are to be brought into a stable homogeneous mixture.

Suitable emulsifiers which are used in the food-processing industry are selected from: ascorbyl palmitate (E 304) lecithin (E 322) phosphoric acid (E 338) sodium phosphate (E 339) potassium phosphate (E 340) calcium phosphate (E 341) magnesium orthophosphate (E 343) propylene glycol alginate (E 405) polyoxyethylene(8)stearate (E 430) polyoxyethylene stearate (E 431) ammonium phosphatides (E 442) sodium phosphate and potassium phosphate (E 450) sodium salts of edible fatty acids (E 470 a) mono- and diglycerides of edible fatty acids (E 471) acetic acid monoglycerides (E 472 a) lactic acid monoglycerides (E 472 b) citric acid monoglycerides (E 472 c) tartaric acid monoglycerides (E 472 d) diacetyltartaric monoglycerides (E 472 e) sugar esters of edible fatty acids (E 473) sugar glycerides (E 474) polyglycerides of edible fatty acids (E 475) polyglycerol polyricinoleate (E 476) propylene glycol esters of edible fatty acids (E 477) sodium stearoyl lactylate (E 481) calcium stearoyl-2-lactylate (E 482) stearyl tartrate (E 483) sorbitan monostearate (E 491) stearic acid (E 570).

Thickeners

Thickeners are materials which are primarily able to bind water. By withdrawal of unbound water, the viscosity increases. From a concentration characteristic for each thickener, in addition to this effect, network effects further occur which lead to a usually disproportionate increase in viscosity. In this case the molecules are said to “communicate” with one another, i.e. entangle. Most thickeners are linear or branched macromolecules (e.g. polysaccharides or proteins) which can interact with one another by intermolecular interactions, such as hydrogen bridges, hydrophobic interactions or ionic relationships. Extreme cases of thickeners are phyllosilicates (bentonites, hectorites) or hydrated SiO₂ particles that are present in dispersed form as particles and can bind water in the solid-like structure thereof or, owing to the described interactions, can interact with one another. Examples are:

E 400—alginic acid
E 401—sodium alginate
E 402—potassium alginate
E 403—ammonium alginate
E 404—calcium alginate
E 405—propylene glycol alginate
E 406—agar agar
E 407—carragheenan, furcelleran
E 407—carob bean meal
E 412—guar seed meal
E 413—tragacanth

### E 414—gum Arabic

E 415—xanthan
E 416—karaya (Indian tragacanth)
E 417—tara seed meal (Peruvian carob bean meal)
E 418—gellan
E 440—pectin, opecta
E 440ii—amidated pectin
E 460—microcrystalline cellulose, cellulose powder
E 461—methyl cellulose
E 462—ethyl cellulose
E 463—hydroxypropyl cellulose
E 465—methyl ethyl cellulose
E 466—carboxymethyl cellulose, sodium carboxymethyl cellulose

Vitamins

In a further embodiment of the present invention, the food additives can contain vitamins as a further optional group of additives. Vitamins have the most varied biochemical modes of action. Some act similarly to hormones and regulate the mineral metabolism (e.g. vitamin D), or act on the growth of cells and tissue and also cell differentiation (e.g. some forms of vitamin A). Others are antioxidants (e.g. vitamin E and under certain circumstances, also vitamin C). The greatest number of vitamins (e.g. the B vitamins) are precursors for enzymatic cofactors which support enzymes in catalysing certain processes in metabolism. In this connection, vitamins can sometimes be closely bound to the enzymes, for example as a part of the prosthetic group: one example thereof is biotin which is a part of the enzyme that is responsible for the synthesis of fatty acids. Vitamins, on the other hand, can also be less strongly bound and then act as co-catalysts, for example as groups that may be readily cleaved off and transport chemical groups or electrons between the molecules. Thus, for example folic acid transports methyl, formyl and methylene groups into the cell. Although their support in enzyme-substrate reactions is well known, their remaining properties are also of great importance to the body.

In the context of the present invention, as vitamins, substances come into consideration that are selected from the group consisting of

Vitamin A (retinol, retinal, betacarotene),

Vitamin B₁ (thiamine),

Vitamin B₂ (riboflavin),

Vitamin B₃ (niacin, niacinamide),

Vitamin B₅ (pantothenic acid),

Vitamin B₆ (pyridoxin, pyridoxamine, pyridoxal),

Vitamin B₇ (biotin),

Vitamin B₉ (folic acid, folinic acid),

Vitamin B₁₂ (cyanocobalamin, hydroxy cobalamin, methyl cobalamin),

Vitamin C (ascorbic acid),

Vitamin D (cholecalciferol),

Vitamin E (tocopherols, tocotrienols) and

Vitamin K (phylloquinone, menaquinone).

The preferred vitamins, in addition to ascorbic acid, are the group of tocopherols.

Antioxidants

In the food industry, not only natural, but also synthetic antioxidants are used. Natural and synthetic antioxidants differ, primarily in that the former occur naturally in the diet and the latter are produced synthetically. For instance, natural antioxidants, where they are to be used as a food additive, are obtained, for example from plant oils. Vitamin E—also known as tocopherol—is frequently produced, for example, from soybean oil. Synthetic antioxidants such as propyl gallate, octyl gallate and dodecyl gallate are, in contrast, obtained by chemical synthesis. The gallates can trigger allergies in sensitive persons. Further antioxidants that are useable in compositions of the present invention are: sulphur dioxide, E 220 sulphites sodium sulphite, E 221 sodium hydrogensulphite, E 222 sodium disulphite, E 223 potassium disulphite, E 224 calcium sulphite, E 226 calcium hydrogensulphite, E 227 potassium hydrogensulphite, E 228 lactic acid, E 270 ascorbic acid, E 300 sodium L-ascorbate, E 301 calcium L-ascorbate, E 302 esters of ascorbic acid, E 304 tocopherol, E 306 alpha-tocopherol, E 307 gamma-tocopherol, E 308 delta-tocopherol, E 309 propyl gallate, E 310 octyl gallate, E 311 dodecyl gallate, E 312 isoascorbic acid, E 315 sodium isoascorbate, E 316 tertiary-butylhydroquinone (TBHQ), E 319 butylated hydroxyanisol, E 320 butylated hydroxytoluene, E 321 lecithin, E 322 citric acid, E 330 salts of citric acid (E 331 & E 332) sodium citrate, E 331 potassium citrate, E 332 calcium disodium EDTA, E 385 diphosphates, E 450 disodium diphosphate, E 450a trisodium diphosphate, E 450b tetrasodium diphosphate, E 450c dipotassium diphosphate, E 450d tripotassium diphosphate, E 450e dicalcium diphosphate, E 450f calcium dihydrogendiphosphate, E 450g triphosphates, E 451 pentasodium triphosphate, E 451a pentapotassium triphosphate, E 451b polyphosphate, E 452 sodium polyphosphate, E 452a potassium polyphosphate, E 452b sodium calcium polyphosphate, E 452c calcium polyphosphate, E 452d tin(II) chloride, E 512.

Flavourings

The preparations according to the invention can contain one or more flavourings. Typical examples comprise: acetophenone, allyl caproate, alpha-ionone, beta-ionone, anisaldehyde, anisyl acetate, anisyl formate, benzaldehyde, benzothiazole, benzyl acetate, benzyl alcohol, benzyl benzoate, beta-ionone, butyl butyrate, butyl caproate, butylidene phthalide, carvone, camphene, caryophyllene, cineole, cinnamyl acetate, citral, citronellol, citronellal, citronellyl acetate, cyclohexyl acetate, cymene, damascone, decalactone, dihydrocoumarin, dimethyl anthranilate, dimethyl anthranilate, dodecalactone, ethoxyethyl acetate, ethyl butyric acid, ethyl butyrate, ethyl caprate, ethyl caproate, ethyl crotonate, ethylfuraneol, ethylguaiacol, ethyl isobutyrate, ethyl isovalerate, ethyl lactate, ethyl methyl butyrate, ethyl propionate, eucalyptol, eugenol, ethyl heptylate, 4-(p-hydroxyphenyl)-2-butanone, gamma-decalactone, geraniol, geranyl acetate, grapefruit aldehyde, methyl dihydrojasmonate (e.g. Hedion®), heliotropin, 2-heptanone, 3-heptanone, 4-heptanone, trans-2-heptenal, cis-4-heptenal, trans-2-hexenal, cis-3-hexenol, trans-2-hexenoic acid, trans-3-hexenoic acid, cis-2-hexenyl acetate, cis-3-hexenyl acetate, cis-3-hexenyl caproate, trans-2-hexenyl caproate, cis-3-hexenyl formate, cis-2-hexyl acetate, cis-3-hexyl acetate, trans-2-hexyl acetate, cis-3-hexyl formate, para-hydroxybenzylacetone, isoamyl alcohol, isoamyl isovalerate, isobutyl butyrate, isobutyraldehyde, isoeugenol methyl ether, isopropyl methyl thiazole, lauric acid, levulinic acid, linalool, linalool oxide, linalyl acetate, menthol, menthofuran, methylanthranilate, methylbutanol, methylbutyric acid, 2-methylbutyl acetate, methyl caproate, methyl cinnamate, 5-methylfurfural, 3,2,2-methylcyclopentenolone, 6,5,2-methylheptenone, methyldihydrojasmonate, methyl jasmonate, 2-methyl methylbutyrate, 2-methyl-2-pentenolic acid, methyl thiobutyrate, 3,1-methylthiohexanol, 3-methylthiohexyl acetate, nerol, neryl acetate, trans,trans-2,4-nonadienal, 2,4-nonadienol, 2,6-nonadienol, 2,4-nonadienol, nootcatone, delta octalactone, gamma-octalactone, 2-octanol, 3-octanol, 1,3-octenol, 1-octyl acetate, 3-octyl acetate, palmitic acid, paraldehyde, phellandrene, pentanedione, phenylethyl acetate, phenylethyl alcohol, phenylethyl isovalerate, piperonal, propionaldehyde, propyl butyrate, pulegone, pulegol, sinensal, sulfurol, terpinene, terpineol, terpinolene, 8,3-thiomenthanone, 4,4,2-thiomethylpentanone, thymene, delta-undecalactone, gamma-undecalactone, valencene, valeric acid, vanillin, acetoin, ethylvanillin, ethylvanillin isobutyrate (=3-ethoxy-4-isobutyryloxybenzaldehyde), 2,5-dimethyl-4-hydroxy-3(2H)furanone and derivatives thereof (here preferably homofuraneol (=2-ethyl-4-hydroxy-5-methyl-3(2H)furanone), homofuronol (=2-ethyl-5-methyl-4-hydroxy-3(2H)furanone and 5-ethyl-2-methyl-4-hydroxy-3(2H)-furanone), maltol and maltol derivatives (here, preferably ethylmaltol), coumarin and coumarin derivatives, gamma-lactones (here preferably gamma-undecalactone, gamma-nonalactone, gamma-decalactone), delta-lactones (here preferably 4-methyldeltadecalactone, massoilactone, deltadecalactone, tuberolactone), methyl sorbate, divanillin, 4-hydroxy-2(or 5)-ethyl-5(or 2)-methyl-3(2H)furanone, 2-hydroxy-3-methyl-2-cyclopentenone, 3-hydroxy-4,5-dimethyl-2(5H)-furanone, acetic acid isoamyl ester, butyric acid ethyl ester, butyric acid n-butyl ester, butyric acid isoamyl ester, 3-methyl butyric acid ethyl ester, n-hexanoic acid ethyl ester, n-hexanoic acid allyl ester, n-hexanoic acid-n-butyl ester, n-octanoic acid ethyl ester, ethyl-3-methyl-3-phenyl glycidate, ethyl-2-trans-4-cis-decadienoate, 4-(p-hydroxyphenyl)-2-buta none, 1,1-dimethoxy-2,2,5-trimethyl-4-hexane, 2,6-dimethyl-5-hepten-1-al and phenylacetaldehyde, 2-methyl-3-(methylthio)furan, 2-methyl-3-furanthiol, bis(2-methyl-3-furyl)disulphide, furfurylmercaptan, methional, 2-acetyl-2-thiazoline, 3-mercapto-2-pentanone, 2,5-dimethyl-3-furanthiol, 2,4,5-trimethylthiazole, 2-acetylthiazole, 2,4-dimethyl-5-ethylthiazole, 2-acetyl-1-pyrroline, 2-methyl-3-ethyl pyrazine, 2-ethyl-3,5-dimethylpyrazine, 2-ethyl-3,6-dimethylpyrazine, 2,3-diethyl-5-methylpyrazine, 3-isopropyl-2-methoxypyrazine, 3-isobutyl-2-methoxypyrazine, 2-acetylpyrazine, 2-pentylpyridine, (E,E)-2,4-decadienal, (E,E)-2,4-nonadienal, (E)-2-octenal, (E)-2-nonenal, 2-undecenal, 12-methyltridecanal, 1-penten-3-one, 4-hydroxy-2,5-dimethyl-3(2H)-furanone, guaiacol, 3-hydroxy-4,5-dimethyl-2(5H)-furanone, 3-hydroxy-4-methyl-5-ethyl-2(5H)-furanone, cinnamaldehyde, cinnamal alcohol, methyl salicylate, isopulegol and also (here not explicitly stated) stereoisomers, enantiomers, positional isomers, diastereomers, cis/trans-isomers and/or epimers of said substances.

Taste Enhancers

The preparations can furthermore contain additional flavourings for intensifying taste impressions. In addition, flavour mixtures and products preferred according to the invention can also comprise flavourings for masking bitter and/or astringent taste impressions (taste correctors). The (further) taste correctors are selected, e.g. from the following list: nucleotides (e.g. adenosine 5′-monophosphate, cytidine 5′-monophosphate) or pharmaceutically acceptable salts thereof, lactisols, sodium salts (e.g. sodium chloride, sodium lactate, sodium citrate, sodium acetate, sodium gluconoate), further hydroxy flavanones (e.g. eriodictyol, homoeriodictyol or sodium salts thereof), in particular according to US 2002/0188019, hydroxybenzamides according to DE 10 2004 041 496 (e.g. 2,4-dihydroxybenzoic acid vanillylamide, 2,4-dihydroxybenzoic acid N-(4-hydroxy-3-methoxybenzyl)amide, 2,4,6-trihydroxybenzoic acid N-(4-hydroxy-3-methoxybenzyl)amide, 2-hydroxybenzoic acid N-4-(hydroxy-3-methoxybenzyl)amide, 4-hydroxybenzoic acid N-(4-hydroxy-3-methoxybenzyl)amide, 2,4-dihydroxybenzoic acid N-(4-hydroxy-3-methoxybenzyl)amide monosodium salt, 2,4-dihydroxybenzoic acid N-2-(4-hydroxy-3-methoxyphenyl)ethylamide, 2,4-dihydroxybenzoic acid N-(4-hydroxy-3-ethoxybenzyl)amide, 2,4-dihydroxybenzoic acid N-(3,4-dihydroxybenzyl)amide and 2-hydroxy-5-methoxy-N-[2-(4-hydroxy-3-methoxyphenyl)ethyl]amide (Aduncamid), 4-hydroxybenzoic acid vanillylamide), bitter-masking hydroxydeoxybenzoin, e.g. according to WO 2006/106023 (e.g. 2-(4-hydroxy-3-methoxyphenyl)-1-(2,4,6-tri-hydroxyphenyl)ethanone, 1-(2,4-dihydroxyphenyl)-2-(4 hydroxy-3-methoxyphenyl)ethanone, 1-(2-hydroxy-4-methoxyphenyl)-2-(4 hydroxy-3-methoxyphenyl)ethanone), amino acids (e.g. gamma-aminobutyric acid according to WO 2005/096841 for reducing or masking an unpleasant taste impression such as bitterness), malic acid glycosides according to WO 2006/003107, salt-tasting mixtures according to PCT/EP 2006/067120 diacetyltrimers according to WO 2006/058893, mixtures of whey proteins with lecithins and/or bitter-masking substances such as gingerdiones according to WO 2007/003527.

Preferred flavourings are those that cause a sweet taste impression, wherein the flavouring or the further flavourings that cause a sweet taste impression are preferably selected from the group consisting of: vanillin, ethylvanillin, ethylvanillin isobutyrate (=3-ethoxy-4-isobutyryloxybenzaldehyde), furaneol (2,5-dimethyl-4-hydroxy-3(2H)-furanone) and derivatives (e.g. homofuraneol, 2-ethyl-4-hydroxy-5-methyl-3(2H)-furanone), homofuronol (2-ethyl-5-methyl-4-hydroxy-3(2H)-furanone and 5-ethyl-2-methyl-4-hydroxy-3(2H)-furanone), maltol and derivatives (e.g. ethylmaltol), coumarin and derivatives, gamma-lactones (e.g. gamma-undecalactone, gamma-nonalactone), delta-lactones (e.g. 4-methyldeltalactone, massoilactone, deltadecalactone, tuberolactone), methyl sorbate, divanillin, 4-hydroxy-2(or 5)-ethyl-5(or 2)-methyl-3(2H)furanone, 2-hydroxy-3-methyl-2-cyclopentenones, 3-hydroxy-4,5-dimethyl-2(5H)-furanone, fruit esters and fruit lactones (e.g. acetic acid n-butyl ester, acetic acid isoamyl ester, propionic acid ethyl ester, butyric acid ethyl ester, butyric acid n-butyl ester, butyric acid isoamyl ester, 3-methylbutyric acid ethyl ester, n-hexanoic acid ethyl ester, n-hexanoic acid allyl ester, n-hexanoic acid n-butyl ester, n-octanoic acid ethyl ester, ethyl 3-methyl-3-phenylglycidate, ethyl 2-trans-4-cis-decadienoate), 4-(p-hydroxyphenyl)-2-butanone, 1,1-dimethoxy-2,2,5-trimethyl-4-hexane, 2,6-dimethyl-5-hepten-1-al, 4-hydroxycinnamic acid, 4-methoxy-3-hydroxycinnamic acid, 3-methoxy-4-hydroxycinnamic acid, 2-hydroxycinnamic acid, 2,4-dihydroxybenzoic acid, 3-hydroxybenzoic acid, 3,4-dihydroxybenzoic acid, vanillic acid, homovanillic acid, vanillomandelic acid, and phenylacetaldehyde.

Food Dyes

Food dyes, or dyes for short, are food additives for colouring foods. Dyes are subdivided into the groups of natural dyes and synthetic dyes. The nature-identical dyes are likewise of synthetic origin. The nature-identical dyes are synthetic reproductions of colouring substances occurring in nature. Suitable dyes for use in the present composition are selected from: curcumin, E 100 riboflavin, lactoflavin, Vitamin B2, E 101 tartrazine, E 102 quinoline yellow, E 104 yellow orange S, yellow orange RGL, E 110 cochenille, carminic acid, true carmine, E 120 azorubin, carmoisine, E 122 amaranth, E 123 cochenille red A, ponceau 4 R, Victoria scarlet 4 R, E 124 erythrosine, E 127 allura red AC, E 129 patent blue V, E 131 indigotin, indigo carmine, E 132 brilliant blue FCF, patent blue AE, amidoblue AE, E 133 chlorophylls, chlorophyllins, E 140 copper complexes of chlorophylls, copper-chlorophyllin complex, E 141 brilliant acid green, green S, E 142 caramel colour, alkali-, E 150 a sulphite caramel colour, E 150 b ammonia caramel colour, E 150 c ammonium sulphite caramel colour, E 150 d brilliant black FCF, brilliant black PN, black PN, E 151 vegetable black, E 153 brown FK, E 154 brown HT, E 155 carotene, E 160 a annatto, bixin, norbixin, E 160 b capsanthin, capsorubin, E 160 c lycopene, E 160 d beta-apo-8′-carotenal, apocarotenal, beta-apocarotenal, E 160 e beta-apo-8′-carotenic acid ethyl ester (C30), apocarotenic ester, beta-carotenic acid ester, E 160 f lutein, xanthophyll, E 161 b canthaxanthin, E 161 g betanin, beet red, E 162 anthocyans, E 163 calcium carbonate, E 170 titanium dioxide, E 171 iron oxides, iron hydroxides, E 172 aluminium, E 173 silver, E 174 gold, E 175 lithol rubine BK, rubine pigment BK, E 180.

### INDUSTRIAL APPLICABILITY

The invention further relates to the use of the protein preparations according to the invention as cheese substitute, especially as substitute for semi-hard-cheese.

### EXAMPLES

### Example 1

1000 kg of milk (8° C.) were adjusted to a pH of 4.5 with citric acid and admixed with rennet. The mixture was introduced into a screw extruder that was heated externally to about 100° C. and in which a pressure of about 200 bar prevailed. Under these conditions, the milk was coagulated during passage through the extruder. The liquid arising from the process was ejected via an expansion section. At a throughput of about 500 kg/h, 800 kg of a brittle protein mass were then obtained, which mass had a texture similar to white cheese.

### Example 2

5000 kg of milk (8° C.) were adjusted to a pH of 4.5 with citric acid and admixed with rennet. The mixture was introduced into a screw extruder which was externally heated to about 150° C. and in which a pressure of about 250 bar prevailed. Under these conditions, the milk was coagulated during passage through the extruder. The liquid arising in the process was kneaded into the product. At a throughput of about 1000 kg/h, 4800 kg of a virtually solid protein mass were then obtained, which mass had a texture similar to semi-hard-cheese.

### Example 3

1000 kg of milk concentrate were admixed with rennet. The mixture was introduced together with 20 kg of citric acid into a screw extruder which was externally heated to about 100° C. and in which a pressure of about 200 bar prevailed. Under these conditions, the milk was coagulated during passage through the extruder. The liquid arising in the process was ejected via an expansion section. At a throughput of about 500 kg/h, 800 kg of a brittle protein mass were then obtained, which mass had a texture similar to white cheese.

1. A solid protein preparation, obtainable by
(a) feeding proteins from natural sources into a screw extruder,
(b) adding rennet to the mass during the extrusion operation, and
(c) shaping the extruded mass after it leaves the extruder.

2. A method for production of a protein preparation, comprising
(a) feeding proteins from natural sources into a screw extruder,
(b) adding rennet to the mass during the extrusion operation, and
(c) shaping the extruded mass of step (b) after it leaves the extruder.

3. The method of claim 2, wherein proteins are used which are selected from the group consisting of plant proteins, milk proteins and mixtures thereof.

4. The method of claim 3, comprising using wheat proteins, pea proteins or potato proteins.

5. The method of claim 2, comprising using milk proteins and/or whey proteins.

6. The method of claim 2, comprising using proteins having a dry matter in the range from about 15 to about 60% by weight.

7. The method of claim 2, comprising using proteins that contain casein and/or lactose as further components.

8. The method of claim 2, wherein the extrusion is carried out in a double-screw extruder.

9. The method of claim 2, wherein the extrusion is carried out at a temperature in the range from about 50 to about 150° C.—based on the extruder barrel temperature.

10. The method of claim 2, wherein the extrusion is carried out at a pressure from about 1 to about 300 bar.

11. The method of claim 2, wherein the extrusion is carried out with a throughput from about 200 to about 7000 kg/h.

12. The method of claim 2, comprising adding a food acid source as denaturant to the mass during the extrusion, which food acid source is selected from the group consisting of citric acid, lactic acid, glucono-delta-lactone and mixtures thereof.

13. (canceled)

14. The method of claim 2, comprising adding starter cultures, probiotic microorganisms, prebiotic substances, emulsifiers, thickeners, flavourings, taste enhancers, salts, herbs, vitamins, antioxidants, food dyes and the like to the mass during the extrusion.

15. (canceled)
